(19) United States
(12) Patent Application Publication
(10) Pub. No.: US 2007/0113901 A1
(43) Pub. Date: May 24, 2007

(54) Cooling apparatus

(76) Inventor: Joo Woong Youn, Seoul (KR)

Correspondence Address: MORGAN, LEWIS & BOCKIUS LLP (SF), 2 PALO ALTO SQUARE, 3000 El Camino Real, Suite 700, PALO ALTO, CA, 94306, US

(21) Appl. No.: 11/305,733

(22) Filed: Dec. 15, 2005

(30) Foreign Application Priority Data
Nov. 24, 2005 (KR) 10-2005-0112810

(51) Int. Cl. F16K 31/12

(52) U.S. Cl. 137/485

(57) ABSTRACT

In a cooling apparatus, the amount of coolant flowing into an inlet and exhausted outlet is equalized, so cooling performance is not deteriorated.

### CROSS-REFERENCE TO RELATED APPLICATION

This application claims priority to and the benefit of Korean Patent Application No. 10-2005-0112810 filed in the Korean Intellectual Property Office on Nov. 24, 2005, the entire contents of which are incorporated herein by reference.

### BACKGROUND OF THE INVENTION

(a) Field of the Invention

The present invention relates to a cooling apparatus. More particularly, the present invention relates to a cooling apparatus including a spool valve mounted to an inlet and outlet for coolant.

(b) Description of the Related Art

Generally, a cooling apparatus includes an inlet and an outlet such that coolant flows therein and is exhausted therefrom. The coolant flows into respective coolant inlets, circulates around of the motor and the generator, and is exhausted to the respective coolant outlets. However, because vibrations are transmitted to the coolant while driving the vehicle, a problem occurs in that the coolant is irregularly supplied.

Because a supply of the coolant is irregular, the performance of the cooling apparatus is problematically deteriorated. The above information disclosed in this Background section is only for enhancement of understanding of the background of the invention and therefore it may contain information that does not form the prior art that is already known in this country to a person of ordinary skill in the art.

### SUMMARY OF THE INVENTION

Embodiments of the present invention provide a cooling apparatus having advantages of supplying a constant amount of coolant.

An exemplary cooling apparatus in which a coolant flows and is exhausted therefrom according to an embodiment of the present invention includes an inlet wherein the coolant flows and having a diameter formed to become small in a direction that the coolant flows, an outlet from which the coolant is exhausted and having a diameter formed to become small in a direction that the coolant flows, and a spool valve disposed between the inlet and the outlet and variably regulating a cross-section of the outlet or the inlet corresponding to a coolant amount flowing into the inlet or exhausting from the outlet such that the spool valve regulates a velocity of the coolant corresponding to changes of the coolant amount flowing into the inlet or exhausting from the outlet.

The spool valve comprises cases disposed to both ends of the penetrating passage and having a diameter formed to become small in a direction of the coolant flow, a spool disposed to the penetrating passage and having a diameter formed to become small in a direction of the coolant flow, and an elastic member disposed between the spool and a protrusion formed to an interior circumference of the penetrating passage such that the elastic member moves the spool.

A cooling apparatus in which a coolant flows and is exhausted from includes an inlet into which a coolant flows, an outlet through which the coolant is exhausted, a penetrating passage connecting the inlet and the outlet, and a spool valve disposed to the penetrating passage and regulating a coolant amount corresponding to changes of the coolant amount flowing into the inlet or exhausting from the outlet.

The spool valve includes cases disposed to both ends of the penetrating passage and having a diameter formed to become small in a direction of the coolant flow, a spool disposed to the penetrating passage and having a diameter formed to become small in a direction of the coolant flow, and an elastic member disposed between the spool and a protrusion formed to an interior circumference of the penetrating passage such that the elastic member moves the spool.

### BRIEF DESCRIPTION OF THE DRAWINGS

FIG. 1 shows a cooling apparatus according to an exemplary embodiment of the present invention.

### DETAILED DESCRIPTION OF THE EMBODIMENTS

An exemplary embodiment of the present invention will hereinafter be described in detail with reference to the accompanying drawings.

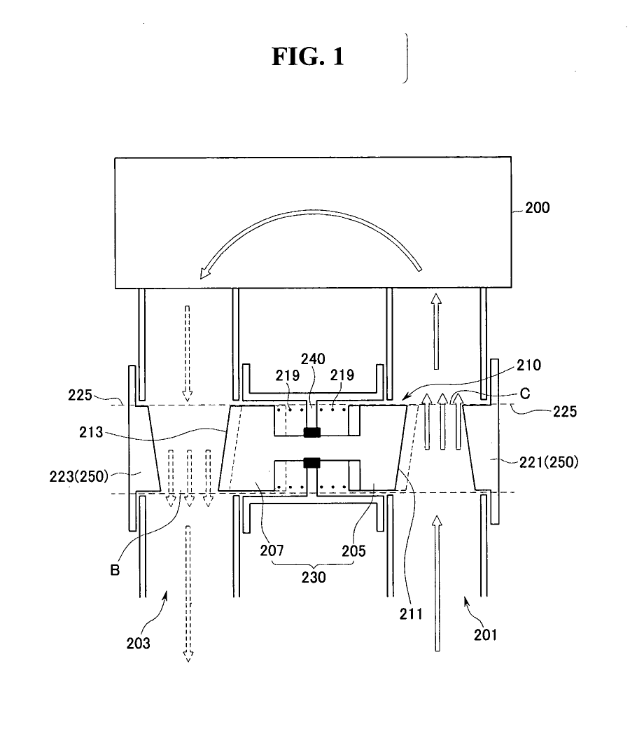

As shown in FIG. 1, according to an exemplary embodiment of the present invention, the cooling apparatus includes an inlet 201, an outlet 203, and a spool valve 210.

The inlet 201 through which the coolant flows has a diameter formed to become small in a coolant flow direction (referring to solid line arrows in FIG. 1).

The outlet 203 through which the coolant is exhausted has a diameter formed to become small in a coolant flow direction (referring to dotted line arrows in FIG. 1).

That is, the coolant that has flowed into the inlet 201 is exhausted from the outlet 203 after cooling a generator or a motor 200.

The spool valve 210 is disposed between the inlet 201 and the outlet 203 and variably regulates a cross-section of the outlet 203 or the inlet 201 corresponding to a coolant amount flowing into the inlet 201 or exhausting from the outlet 203, such that the spool valve 210 regulates a velocity of the coolant corresponding to changes of the coolant amount flowing into the inlet 201 or exhausting from the outlet 203.

The spool valve 210 includes a spool 230 and an elastic member 219.

The spool 230 defines slanted surfaces 211 and 213 such that the diameter of the inlet 201 or the outlet 203 can be made to become small in a direction that the coolant flows. The spool 230 includes a spool 205 disposed to the inlet 201 and a spool 207 disposed to the outlet 203.

That is, the slanted surface 211 of the spool 205 disposed to the inlet 201 is formed such that the inlet 201 becomes narrow in the direction that the coolant flows and the slanted surface 213 of the spool 207 disposed to the outlet 203 is formed such that the outlet 203 becomes narrow in the direction that the coolant flows.

The elastic member 219 supplies an elastic force to the spool 230 to locate it at a predetermined position.

According to an exemplary embodiment of the present invention, the elastic member 219 may be realized as a spring.

More particularly, the two spools 205 and 207 are connected with each other, a protrusion 240 is formed between the two spools 205 and 207, and the elastic member 219 is disposed between the protrusion 240 and the two spools 205 and 207.

In addition, outer circumferences of the inlet 201 and the outlet 203 are also formed such that the inlet 201 and the outlet 203 are narrowed in the coolant flow direction.

According to an exemplary embodiment of the present invention, an operation of the spool valve 210 is described hereinafter.

In a case that the amount of the coolant changes because of vehicle vibration, for example, in a case that an amount of the coolant exhausted from the outlet 203 increases, an area B of the outlet 203 becomes wide.

Therefore, referring to the dotted line in FIG. 1, the spool 230 of the spool valve 210 moves a rightward direction.

If the spool 230 moves in the rightward direction, an area C of the inlet 201 becomes narrow.

However, by Bernoulli's law, a velocity of the coolant flowing into the inlet 201 then increases.

As a result, because respective amounts of the coolant flowing through the inlet 201 and the outlet 203 become equal, the cooling performance of the cooling apparatus is not deteriorated.

According to another exemplary embodiment of the present invention, a cooling apparatus includes a penetrating passage 225.

That is, the spool valve 210 is disposed to the penetrating passage 225, and the spool valve 210 includes a case 250 in addition to the spool 230 and the elastic member 219.

The case 250 includes a case 221 disposed to the inlet 201 and a case 223 disposed to the outlet 203, and the case 250 is formed such that the diameter of the inlet 201 and the outlet 203 becomes narrow in the direction that the coolant flows.

Because an operation of the cooling apparatus according to this exemplary embodiment of the present invention is the same as that of the previous exemplary embodiment of the present invention, a detail description thereof is omitted herein.

According to an exemplary embodiment of the present invention, an amount of coolant flowing through the inlet and outlet can be equal and the cooling performance of the cooling apparatus is therefore not deteriorated.

In addition, because the motor and the generator are cooled more efficiently, performance of the motor and the generator can be enhanced.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A cooling apparatus into which a coolant flows and is exhausted from, comprising:
an inlet through which the coolant flows, having a diameter formed to become small in a coolant flow direction;
an outlet through which the coolant is exhausted, having a diameter formed to become small in a coolant flow direction; and
a spool valve disposed between the inlet and the outlet and variably regulating a cross-section of the outlet or the inlet corresponding to a coolant amount flowing into the inlet or exhausting from the outlet, such that the spool valve regulates a velocity of the coolant corresponding to changes of the coolant amount flowing into the inlet or exhausting from the outlet.

2. An apparatus of claim 1,
wherein the spool valve comprises:
a spool defining a slanted surface such that the diameter of the inlet or outlet is formed to become small in a coolant flow direction; and
an elastic member supplying an elastic force to the spool to locate it at a predetermined position.

3. A cooling apparatus into which a coolant flows and is exhausted from, comprising:
an inlet through which a coolant flows;
an outlet through which the coolant is exhausted;
a penetrating passage connecting the inlet and the outlet; and
a spool valve disposed to the penetrating passage and regulating a coolant amount corresponding to changes of the coolant amount flowing into the inlet or exhausting from the outlet.

4. An apparatus of claim 3,
wherein the spool valve comprises:
cases disposed to both ends of the penetrating passage and having a diameter formed to become small in a direction of the coolant flow;
a spool disposed to the penetrating passage and having a diameter formed to become small in a direction of the coolant flow; and
an elastic member disposed between the spool and a protrusion formed to an interior circumference of the penetrating passage such that the elastic member moves the spool.
